(19) United States
(12) Patent Application Publication
(10) Pub. No.: US 2015/0116452 A1
(43) Pub. Date: Apr. 30, 2015

(54) INFORMATION PROCESSING DEVICE, INFORMATION PROCESSING METHOD, AND PROGRAM

(71) Applicant: SONY CORPORATION, Tokyo (JP)

(72) Inventor: Yasuyuki KOGA, Kanagawa (JP)

(21) Appl. No.: 14/499,605

(22) Filed: Sep. 29, 2014

(30) Foreign Application Priority Data
Oct. 24, 2013 (JP) 2013-221123

(51) Int. Cl. H04N 5/232; H04S 7/00

(52) U.S. Cl. CPC H04N 5/23238; H04N 5/23293; H04S 7/303
USPC 348/37

(57) ABSTRACT

There is provided an information processing device including an acquisition unit that acquires a result of a recognition based on image information or audio information about space surrounding an image capture device having an angle of view of 180 degrees or more, and an image capture control unit that controls execution of image capture by the image capture device according to the result of the recognition.

### CROSS REFERENCE TO RELATED APPLICATIONS

This application claims the benefit of Japanese Priority Patent Application JP 2013-221123 filed Oct. 24, 2013, the entire contents of which are incorporated herein by reference.

### BACKGROUND

The present disclosure relates to an information processing device, an information processing method, and a program.

Cameras have become widely prevalent in recent years. For example, cameras having an angle of view of less than 180 degrees are being used by many people. Furthermore, in addition to such typical cameras, cameras having wider angles of view are also starting to be used. As an example, 360 degree cameras and full dome cameras are starting to be used. For this reason, various technologies related to 360 degree cameras and full dome cameras are being proposed.

For example, JP 2012-123091A discloses technology that detects a person on the basis of an image generated via a camera having a 360 degree angle of view, and displays an image on a display in the direction of the detected person. Also, JP 2005-94713A discloses technology that converts a captured image (video image) generated via a camera having a 360 degree angle of view into a panoramic image, and indicates the position of a speaker in the panoramic image with a mark on the basis of audio data.

### SUMMARY

However, with the technology of the related art, including the technology disclosed in the above JP 2012-123091A and JP 2005-94713A, there is a possibility of being unable to efficiently view the result of image capture by a camera having a wide angle of view (for example, 360 degrees). For example, a camera having a wide angle of view (for example, 360 degrees) is installed at some position (such as a position above a table at a party venue, for example), continually captures images over a wide range, and generates a video image covering a long period of time. In such cases, it may take the user a very long time to view the video image resulting from the image capture by the camera. In this way, there is a possibility of being unable to efficiently view the result of image capture by the camera.

Accordingly, it is desirable to provide a mechanism that enables efficient viewing of the result of image capture by an image capture device having a wide angle of view.

According to an embodiment of the present disclosure, there is provided an information processing device including an acquisition unit that acquires a result of a recognition based on image information or audio information about space surrounding an image capture device having an angle of view of 180 degrees or more, and an image capture control unit that controls execution of image capture by the image capture device according to the result of the recognition.

According to an embodiment of the present disclosure, there is provided an information processing method including acquiring a result of a recognition based on image information or audio information about space surrounding an image capture device having an angle of view of 180 degrees or more, and controlling, with a processor, image capture by the image capture device according to the result of the recognition.

According to an embodiment of the present disclosure, there is provided a program causing a computer to execute acquiring a result of a recognition based on image information or audio information about space surrounding an image capture device having an angle of view of 180 degrees or more, and controlling image capture by the image capture device according to the result of the recognition.

According to an embodiment of the present disclosure as described above, it becomes possible to efficiently view the result of image capture by an image capture device having a wide angle of view. Note that the above advantageous effects are not strictly limiting, and that any advantageous effect indicated in the present disclosure or another advantageous effect that may be reasoned from the present disclosure may also be exhibited in addition to, or instead of, the above advantageous effects.

### BRIEF DESCRIPTION OF THE DRAWINGS

FIG. 1 is an explanatory diagram for illustrating an example of the exterior of an image capture device according to an embodiment of the present disclosure;

FIG. 2 is an explanatory diagram for illustrating an example of the horizontal angle of view of an image capture device according to an embodiment;

FIG. 3 is an explanatory diagram for illustrating an example of the vertical angle of view of an image capture device according to an embodiment;

FIG. 4 is a block diagram illustrating an example of a functional configuration of an image capture device according to an embodiment;

FIG. 5 is an explanatory diagram for illustrating an example of person recognition based on image information;

FIG. 6 is an explanatory diagram for illustrating an example of gesture recognition based on image information;

FIG. 7 is an explanatory diagram for illustrating a first example of notifying a person with a display;

FIG. 8 is an explanatory diagram for illustrating a second example of notifying a person with a display;

FIG. 9 is an explanatory diagram for illustrating an example of notifying a person with a display when image capture is conducted;

FIG. 10 is an explanatory diagram for illustrating a first example of a captured image of an image capture device according to an embodiment;

FIG. 11 is an explanatory diagram for illustrating a second example of a captured image of an image capture device according to an embodiment;

FIG. 12 is a block diagram illustrating an example of a hardware configuration of an image capture device according to an embodiment;

FIG. 13 is a flowchart illustrating an example of a diagrammatic flow of information processing according to an embodiment;

FIG. 14 is an explanatory diagram for illustrating an example of a captured image depicting a designated subject at a designated position;

FIG. 15 is an explanatory diagram for illustrating an example of a captured image depicting a partial range that includes the position of a designated subject from an image capture range;

FIG. 16 is a flowchart illustrating an example of a diagrammatic flow of information processing according to a first exemplary modification of an embodiment;

FIG. 17 is a flowchart illustrating an example of a diagrammatic flow of information processing according to a second exemplary modification of an embodiment;

FIG. 18 is a flowchart illustrating an example of a diagrammatic flow of information processing according to a third exemplary modification of an embodiment; and

FIG. 19 is a flowchart illustrating an example of a diagrammatic flow of information processing according to a fourth exemplary modification of an embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will proceed in the following order.

1. Exterior of image capture device

2. Configuration of image capture device
2.1. Functional configuration
2.2. Hardware configuration

3. Process flow

4. Exemplary modifications
4.1. First exemplary modification
4.2. Second exemplary modification
4.3. Third exemplary modification
4.4. Fourth exemplary modification

5. Conclusion

### 1. EXTERIOR OF IMAGE CAPTURE DEVICE

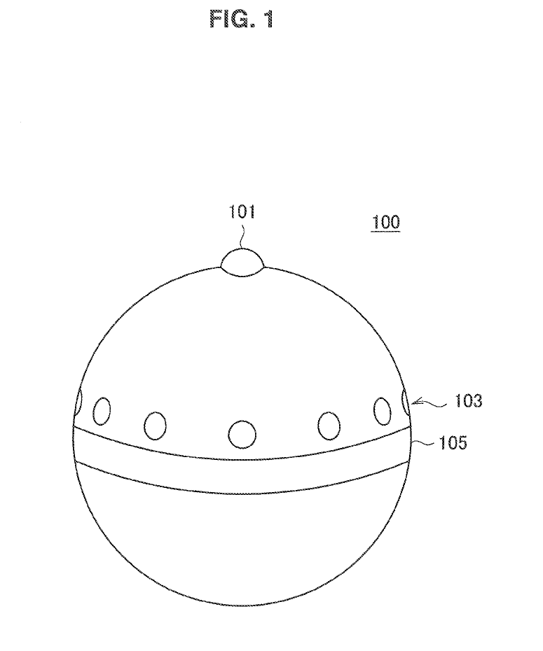

First, the exterior of an image capture device 100 according to the present embodiment will be described with reference to FIGS. 1 to 3. FIG. 1 is an explanatory diagram for illustrating an example of the exterior of an image capture device 100 according to the present embodiment. Referring to FIG. 1, an image capture device 100 is illustrated.

(Camera 101)

The image capture device 100 is equipped with a camera 101. The camera 101 generates image information about the space surrounding the image capture device 100.

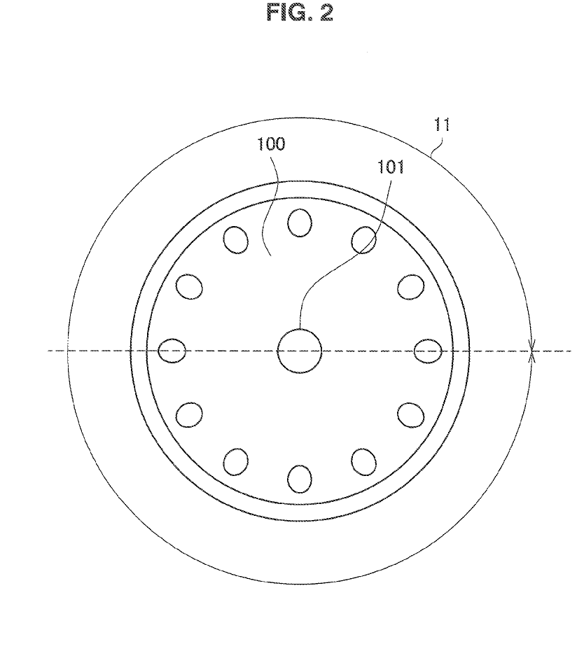

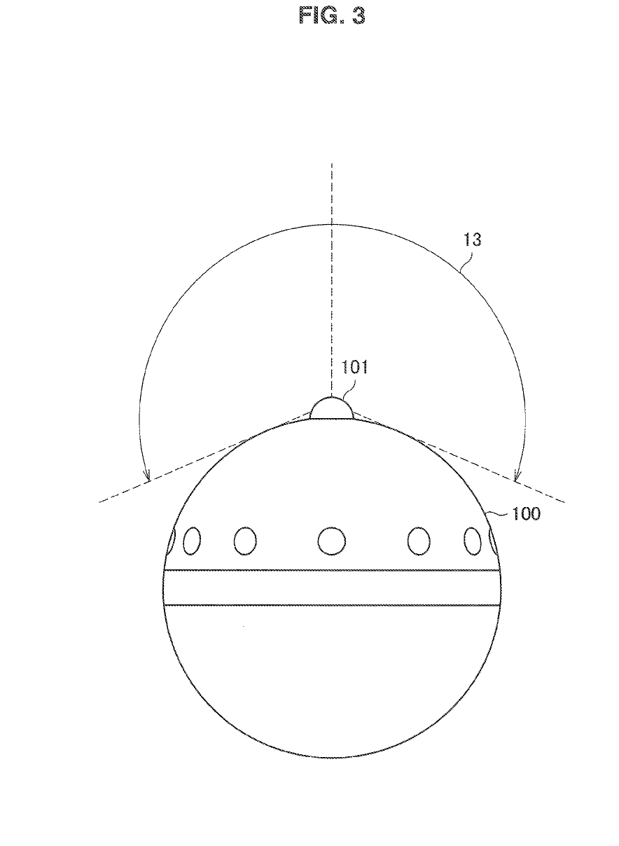

Particularly, in the present embodiment, the camera 101 has an angle of view of 180 degrees or more. In other words, the image capture device 100 has an angle of view of 180 degrees or more. For example, the camera 101 has a horizontal angle of view or a vertical angle of view of 180 degrees or more. As an example, the camera 101 may have a horizontal angle of view and a vertical angle of view of 180 degrees or more. Hereinafter, specific examples regarding this point will be described with reference to FIGS. 2 and 3.

FIG. 2 is an explanatory diagram for illustrating an example of the horizontal angle of view of the image capture device 100. Referring to FIG. 2, the image capture device 100 as viewed from directly overhead is illustrated. The camera 101 has a horizontal angle of view 11. In this example, the horizontal angle of view 11 is 360 degrees. In other words, the image capture device 100 has a horizontal angle of view of 360 degrees.

FIG. 3 is an explanatory diagram for illustrating an example of the vertical angle of view of the image capture device 100. Referring to FIG. 2, the image capture device 100 as viewed edge-on is illustrated. The camera 101 has a vertical angle of view 13. In this example, the vertical angle of view 13 is at least 180 degrees and also less than 360 degrees. In other words, the image capture device 100 has a vertical angle of view that is at least 180 degrees but less than 360 degrees.

(Microphone 103)

For example, the image capture device 100 is additionally equipped with a microphone 103. The microphone 103 generates audio information about the space surrounding the image capture device 100. The microphone 103 is a directional microphone, for example, and includes multiple microphone elements.

(Display Device 105)

For example, the image capture device 100 is additionally equipped with a display device 105. The display device 105 is provided on the outer circumference of the image capture device 100, and for this reason, a person positioned within the image capture range of the image capture device 100 is able to view a display presented by the display device 105.

### 2. CONFIGURATION OF IMAGE CAPTURE DEVICE

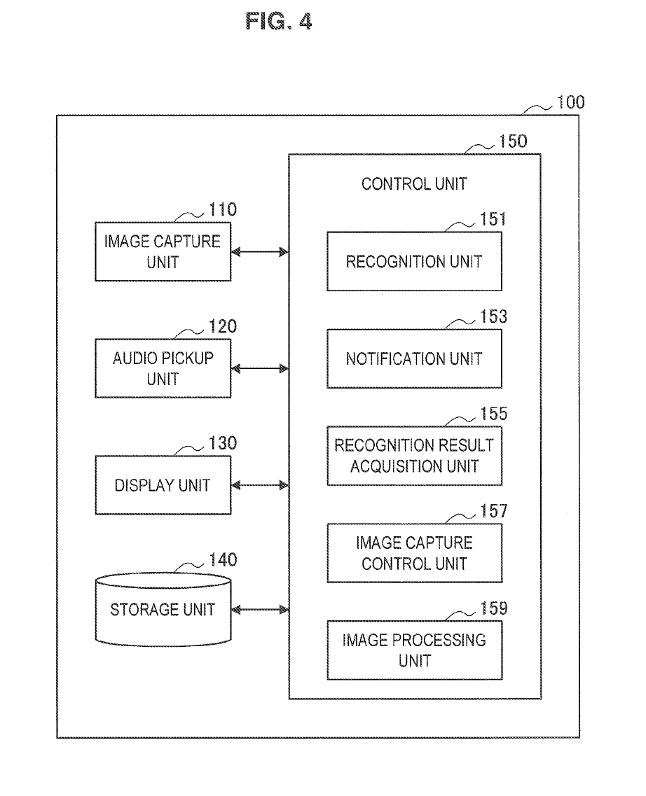

Next, the configuration of an image capture device 100 according to the present embodiment will be described with reference to FIGS. 4 to 12.

<2.1. Functional Configuration>

First, a functional configuration of an image capture device 100 according to the present embodiment will be described with reference to FIGS. 4 to 11. FIG. 4 is a block diagram illustrating an example of a functional configuration of an image capture device 100 according to the present embodiment. Referring to FIG. 4, the image capture device 100 is equipped with an image capture unit 110, an audio pickup unit 120, a display unit 130, a storage unit 140, and a control unit 150.

(Image Capture Unit 110)

The image capture unit 110 generates image information about the space surrounding the image capture device 100. Such image information may be video image information or still image information.

In addition, the image capture unit 110 conducts image capture under control by the control unit 150 (image capture control unit 157). As a result, captured image information is generated. The captured image information is then stored in the storage unit 140. In other words, the captured image information generated by image capture is saved information.

Note that the image capture unit 110 includes the camera 101 described with reference to FIG. 1, for example.

(Audio Pickup Unit 120)

The audio pickup unit 120 generates audio information about the space surrounding the image capture device 100. Note that the audio pickup unit 120 includes the microphone 103 described with reference to FIG. 1, for example.

(Display Unit 130)

The display unit 130 displays an output image from the image capture device 100. For example, the display unit 130 displays an output image under control by the control unit 150. The display unit 130 includes the display device 105.

(Storage Unit 140)

The storage unit 140 temporarily or permanently stores programs and data for the operation of the image capture device 100. Additionally, the storage unit 140 temporarily or permanently stores other data.

Particularly, in the present embodiment, when the image capture unit 110 conducts image capture, the storage unit 140 stores captured image information generated by the image capture, for example.

(Control Unit 150)

The control unit 150 provides various functions of the image capture device 100. The control unit 150 includes a recognition unit 151, a notification unit 153, a recognition result acquisition unit 155, an image capture control unit 157, and an image processing unit 159.

(Recognition Unit 151)

The recognition unit 151 conducts recognition on the basis of image information or audio information about the space surrounding the image capture device 100.

For example, the image information is image information generated via the image capture device 100. In other words, the image information is image information generated by the image capture unit 110. Consequently, image information that enables the ascertaining of the correct direction from the image capture device 100 to a subject is obtained.

Recognition of a Designated Subject

For example, the recognition unit 151 recognizes a designated subject on the basis of the image information or the audio information.

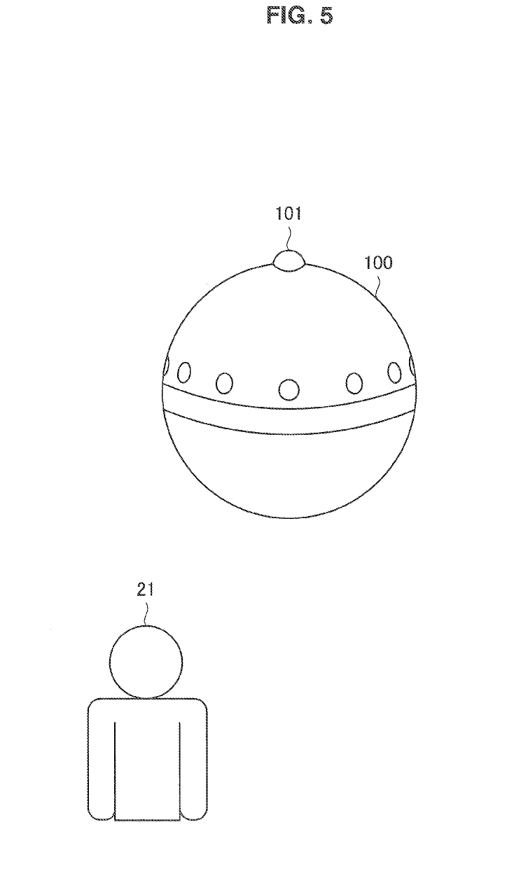

Specifically, for example, the recognition unit 151 recognizes a person on the basis of the image information. As an example, the recognition unit 151 conducts a facial recognition process using the image information. Subsequently, if a person's face is recognized by the facial recognition process, the recognition unit 151 recognizes the person. Hereinafter, a specific example of person recognition will be described with reference to FIG. 5.

FIG. 5 is an explanatory diagram for illustrating an example of person recognition based on image information. Referring to FIG. 5, the image capture device 100 and a person 21 are illustrated. For example, if the person 21 enters within the image capture range of the image capture device 100 (camera 101) in this way, image information generated by the image capture unit 110 (camera 101) will depict the person 21. For this reason, the face of the person 21 is recognized by a facial recognition process using the image information. As a result, the recognition unit 151 recognizes the person 21.

Note that the recognition unit 151 may not recognize all persons, and recognize persons of a size exceeding a designated size in an image of the image information. In other words, if a person's face of a size exceeding a designated size is recognized by the facial recognition process, the recognition unit 151 may recognize the person. Consequently, persons somewhat close to the image capture device 100 are recognized, whereas persons distanced from the image capture device 100 are not recognized.

In addition, the recognition unit 151 may also recognize a person on the basis of the audio information instead of the image information. As an example, the recognition unit 151 may conduct a speech recognition process using the audio information, and if a person's voice is recognized by the speech recognition process, the recognition unit 151 recognizes the person.

Recognition of a Designated Gesture

For example, the recognition unit 151 recognizes a designated gesture on the basis of the image information.

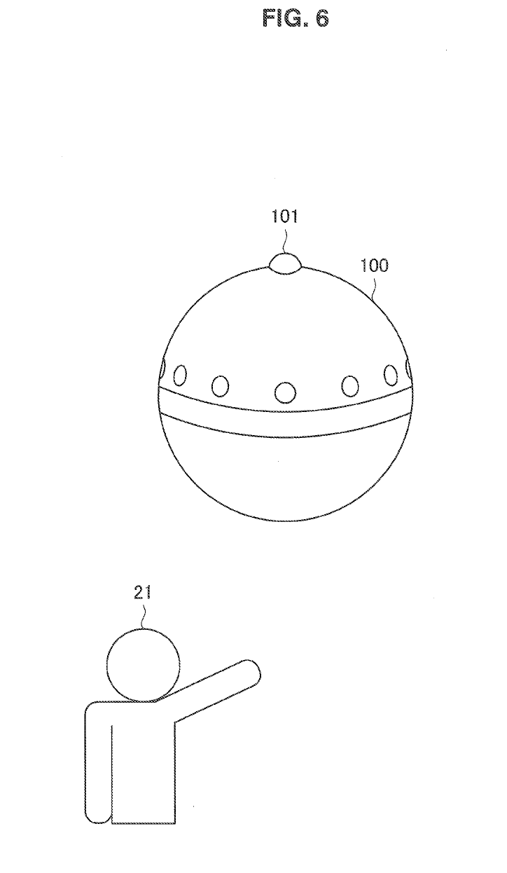

As an example, the designated gesture may be waving one's hand. Hereinafter, a specific example of gesture recognition will be described with reference to FIG. 6.

FIG. 6 is an explanatory diagram for illustrating an example of gesture recognition based on image information. Referring to FIG. 6, the image capture device 100 and a person 21 are illustrated. For example, if the person 21 makes a designated gesture (for example, waving one's hand) within the image capture range of the image capture device 100 (camera 101) in this way, image information generated by the image capture unit 110 (camera 101) will depict the person 21 conducting the designated gesture. For this reason, the recognition unit 151 recognizes the designated gesture with a gesture recognition process using the image information.

Note that the gesture discussed above (waving one's hand) is merely a single example, and that a variety of gestures are applicable.

(Notification Unit 153)

The notification unit 153 notifies a person positioned within the image capture range of the image capture device 100.

Notification Techniques

For example, the notification unit 153 conducts the notification by controlling the display presented by a display device. For example, such a display device is provided in the image capture device 100. In other words, such a display device is the display device 105 (display unit 130) described with reference to FIG. 1. The notification unit 153 conducts the notification by causing the display device 105 (display unit 130) to display an image for notification.

According to notification using such a display, for example, it becomes possible to notify a person without being affected by ambient noise, for example. Also, according to a display on a display device provided by the image capture device 100, it becomes possible to reliably notify a person looking at the image capture device 100.

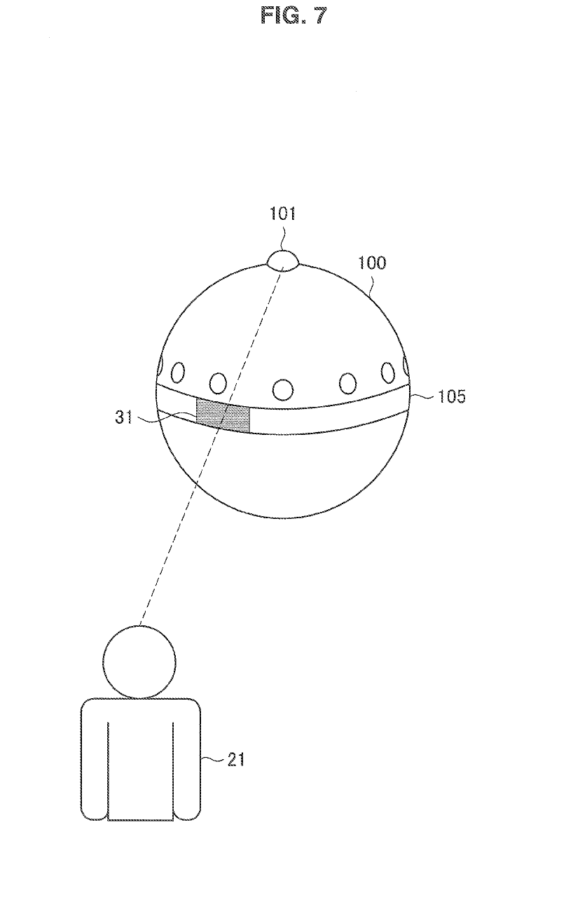

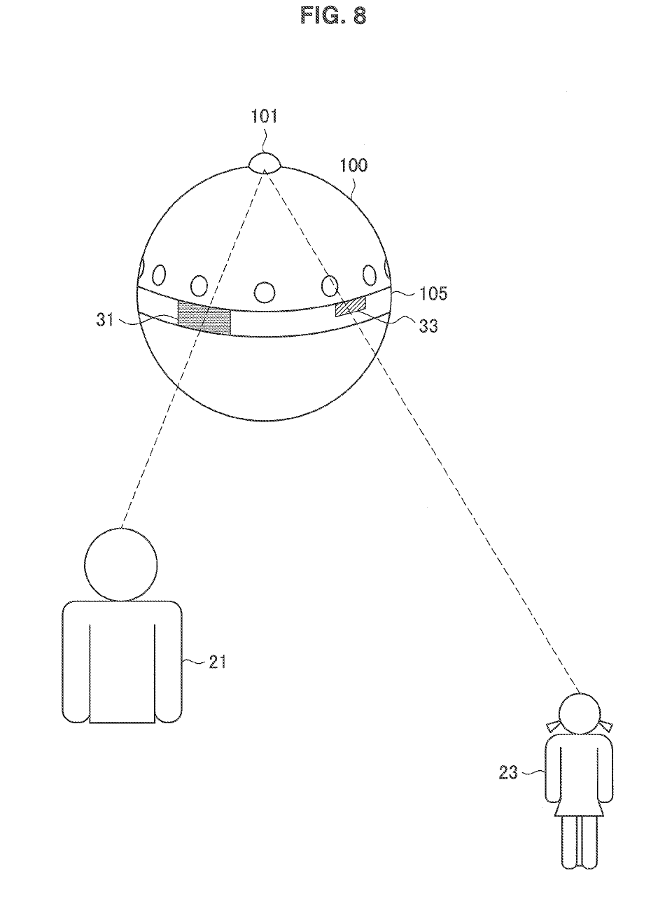

Furthermore, for example, the notification unit 153 conducts the notification by controlling the display so that the display device presents a display in the direction of the person. Hereinafter, specific examples regarding this point will be described with reference to FIGS. 7 and 8.

FIG. 7 is an explanatory diagram for illustrating a first example of notifying a person with a display. Referring to FIG. 7, the image capture device 100 and a person 21 are illustrated. For example, in order to notify the person 21, an image is displayed in a portion 31 of the display device 105 corresponding to the direction of the person 21. As an example, the image is a solid-color figure (for example, a square). In this way, the display device 105 presents a display in the direction of the person 21.

FIG. 8 is an explanatory diagram for illustrating a second example of notifying a person with a display. Referring to FIG. 8, the image capture device 100 as well as a person 21 and a person 23 are illustrated. For example, in order to notify the person 21, an image is displayed in a portion 31 of the display device 105 corresponding to the direction of the person 21. Additionally, in order to notify the person 23, an image is displayed in a portion 33 of the display device 105 corresponding to the direction of the person 23. As an example, these images are solid-color figures (for example, squares). In this way, the display device 105 presents a display in the direction of the person 21 and person 23.

According to notification using such a display, for example, it becomes possible to more reliably notify a specific person.

Note that the display in the direction of a person may also be a display that depends on the recognized person. As an example, the display in the direction of a person may be a display that depends on the distance of the person from the image capture device. For example, as illustrated in FIG. 8, the person 21 is closer to the image capture device 100 than the person 23, and the image displayed in the portion 31 may be larger than the image displayed in the portion 33. As another example, the display in the direction of a person may also be a display that depends on the person's gender. For example, as illustrated in FIG. 8, the person 21 is male while the person 23 is female, and the image displayed in the portion 31 and the image displayed in the portion 33 may be different images (for example, images of different color).

Note that the displays discussed above (such as the display of a solid-color figure and the images of different color, for example) are merely examples, and that various displays are applicable.

Specific Examples of Notification

Notification when a Person is Positioned within Image Capture Range

As a first example, the notification unit 153 notifies a person when that person is positioned within the image capture range of the image capture device 100.

For example, the recognition unit 151 recognizes a person on the basis of image information about the space surrounding the image capture device 100. Subsequently, the notification unit 153 acquires information on the direction in which the person was recognized, and causes the display device 105 (display unit 130) to present a display in that direction.

As one example, as illustrated in FIG. 7, if the person 21 is recognized, an image is displayed in the portion 31 of the display device 105 corresponding to the direction of the person 21. As another example, as illustrated in FIG. 8, if the person 21 and the person 23 are recognized, images are displayed in the portion 31 of the display device 105 corresponding to the direction of the person 21, and the portion 33 corresponding to the direction of the person 23.

Consequently, it becomes possible for a person to know that he or she is positioned within the image capture range of the image capture device 100, for example. Particularly, if an image capture device having a wide angle of view (for example, an angle of view of 360 degrees) is installed, a person may have difficulty judging whether or not he or she is positioned within the image capture range of the image capture device. Alternatively, a person may have difficulty noticing that he or she is positioned within the image capture range of the image capture device. For this reason, when an image capture device having a wide angle of view is used in particular, notification as discussed above is useful.

Notification when the Image Capture Device is Focused on a Person

As a second example, when the image capture device 100 is focused on a person positioned within the image capture range of the image capture device 100, the notification unit 153 notifies that person.

For example, the image capture device 100 may focus on a person positioned within the image capture range of the image capture device 100. Subsequently, the notification unit 153 acquires information on the direction of the person that the image capture device 100 is focused on, and causes the display device 105 (display unit 130) to present a display in that direction.

As one example, referring again to FIG. 7, if the image capture device 100 is focused on the person 21, for example, a blinking image is displayed in the portion 31 of the display device 105 corresponding to the direction of the person 21. As another example, as illustrated in FIG. 8, if the image capture device 100 is focused on the person 23 from among the person 21 and the person 23, a blinking image is displayed in the portion 33 of the display device 105 corresponding to the direction of the person 23. Note that a non-blinking image is displayed in the portion 33 of the display device 105 corresponding to the direction of the person 21.

Consequently, it becomes possible for a person to know that the image capture device 100 is focused on him or her, for example. Particularly, if an image capture device having a wide angle of view (for example, an angle of view of 360 degrees) is installed, a person may have difficulty judging where the image capture device 100 is focused on. For this reason, when an image capture device having a wide angle of view is used in particular, notification as discussed above is useful.

Notification when Image Capture is Conducted

As a third example, when the image capture device 100 conducts image capture, the notification unit 153 notifies a person positioned within the image capture range of the image capture device 100.

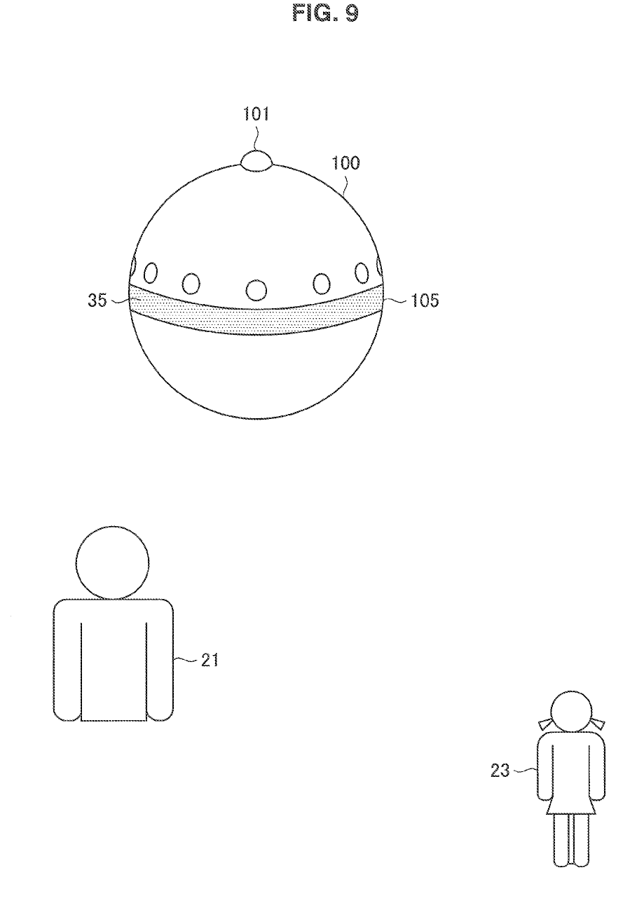

For example, the image capture unit 110 conducts image capture under control by the image capture control unit 157. Subsequently, the notification unit 153 causes the display device 105 (display unit 130) to present a display. Hereinafter, a specific example regarding this point will be described with reference to FIG. 9.

FIG. 9 is an explanatory diagram for illustrating an example of notifying a person with a display when image capture is conducted. Referring to FIG. 9, the image capture device 100, the person 21, and the person 23 are illustrated. For example, in order to notify the person 21 and the person 23, an image is displayed in a portion 35 of the display device 105 corresponding to all directions. As an example, the image is a solid-color image.

Consequently, it becomes possible for a person to know whether or not image capture is being executed. Particularly, if an image capture device having a wide angle of view (for example, an angle of view of 360 degrees) is installed, a person may have difficulty judging whether or not he or she is being captured. For this reason, when an image capture device having a wide angle of view is used in particular, notification as discussed above is useful.

(Recognition Result Acquisition Unit 155)

The recognition result acquisition unit 155 acquires a recognition result based on image information or audio information about the space surrounding an image capture device 100 having an angle of view of 180 degrees or more.

For example, the recognition result acquisition unit 155 acquires a recognition result based on the image information. Specifically, the recognition is the recognition of a designated gesture based on the image information, for example. In other words, the recognition result acquisition unit 155 acquires a recognition result for a designated gesture based on the image information. For example, if the designated gesture is recognized, the recognition result acquisition unit 155 acquires a recognition result indicating that the designated gesture was recognized.

(Image Capture Control Unit 157)

Control of Image Capture Execution

The image capture control unit 157 controls the execution of image capture by the image capture device 100 according to the result of the recognition.

For example, if the recognition result acquisition unit 155 acquires a recognition result based on the image information, the image capture control unit 157 controls the execution of image capture by the image capture device 100 according to the result of the recognition.

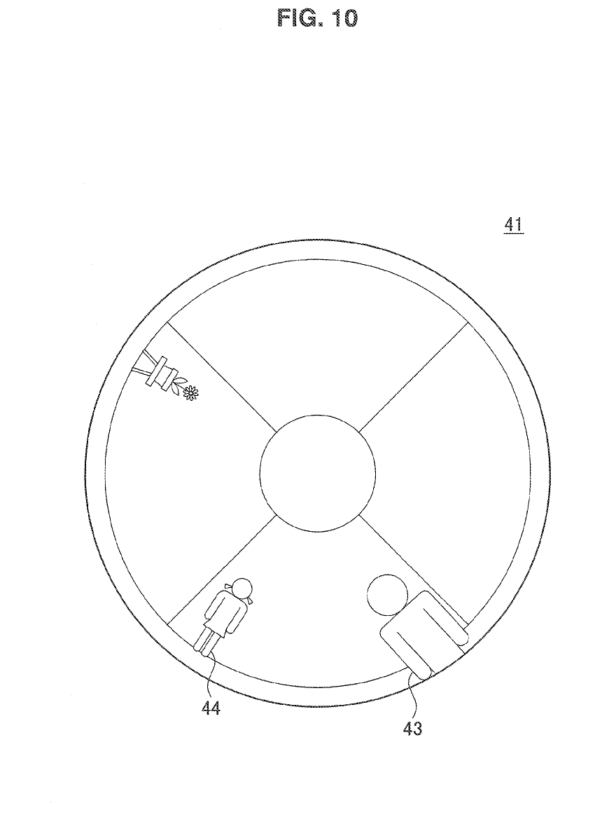

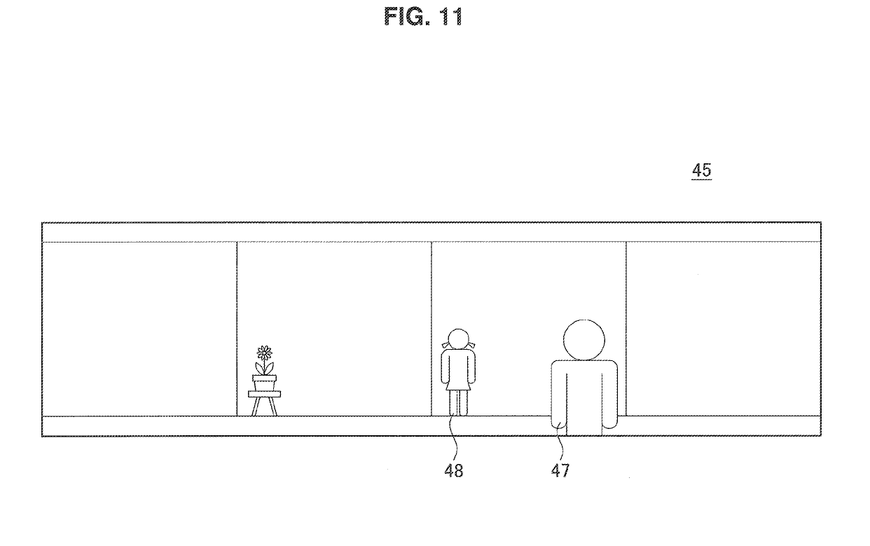

Specifically, the recognition is the recognition of a designated gesture (for example, waving one's hand) based on the image information, for example. If the result of the recognition indicates that the designated gesture was recognized, the image capture control unit 157 causes the image capture unit 110 to conduct image capture. As a result, captured image information is generated. Hereinafter, a specific example of captured image by the image capture device 100 will be described with reference to FIGS. 10 and 11.

FIG. 10 is an explanatory diagram for illustrating a first example of a captured image by the image capture device 100. Referring to FIG. 10, a captured image 41 is illustrated. In this example, the captured image 41 is a full dome image. The person 21 illustrated in FIG. 9 is depicted at a position 43 of the captured image 41. In addition, the person 23 illustrated in FIG. 9 is depicted at a position 44 of the captured image 41. For example, in this way, a full dome image is generated and stored as a captured image.

FIG. 11 is an explanatory diagram for illustrating a second example of a captured image by the image capture device 100. Referring to FIG. 11, a captured image 45 is illustrated. In this example, the captured image 45 is a panoramic image. The person 21 illustrated in FIG. 9 is depicted at a position 47 of the captured image 45. In addition, the person 23 illustrated in FIG. 9 is depicted at a position 48 of the captured image 45. For example, in this way, a panoramic image is generated and stored as a captured image. Note that a panoramic image is generated by conversion from a full dome image, for example.

For example, as above, image capture by the image capture device 100 is controlled according to the result of the recognition. Consequently, it becomes possible to efficiently view the result of image capture by an image capture device having a wide angle of view. More specifically, since image capture is conducted in the case of any recognition (for example, recognition of a gesture), for example, image capture is conducted in a scene that is at least meaningful enough to be captured (for example, a scene that a person wants to capture), and the result of the image capture is saved. For this reason, by viewing the results of such image capture, it becomes possible to view only scenes having some kind of meaning. In this way, it becomes possible to efficiently view the result of image capture.

Also, as discussed above, image capture is executed according to the recognition of a gesture. Consequently, since image capture is conducted during a scene that a person wants to capture, and the result of the image capture is saved, for example, it becomes possible to view only scenes that a person intentionally wanted to capture. Furthermore, it becomes possible for a person who is a subject of an image to intentionally cause the image capture device 100 to capture an image, for example. Also, it becomes possible for a person who is a subject of an image to easily cause the image capture device 100 to capture an image from any position, for example.

Note that the image capture conducted according to the result of the recognition may be the capture of a still image, or the capture of a video image. For example, if the image capture is a still image, a still image may be captured every time the recognition occurs. Also, if the image capture is a video image, when the recognition occurs, the capture of a video image may be started, and capture may end at some timing (such as a timing after a fixed amount of time has elapsed, or a timing at which a person is no longer recognized, for example).

In addition, according to the result of the recognition, a still image may be captured, and in addition, a video image may also be continuously captured. Consequently, it becomes possible to save a still image during a scene having some kind of meaning, while also saving a video image over a long period of time.

Also, a still image may be captured when a first gesture is recognized, whereas a video image may be captured when a second gesture is recognized.

(Image Processing Unit 159)

The image processing unit 159 conducts some kind of image processing.

<2.2. Hardware Configuration>

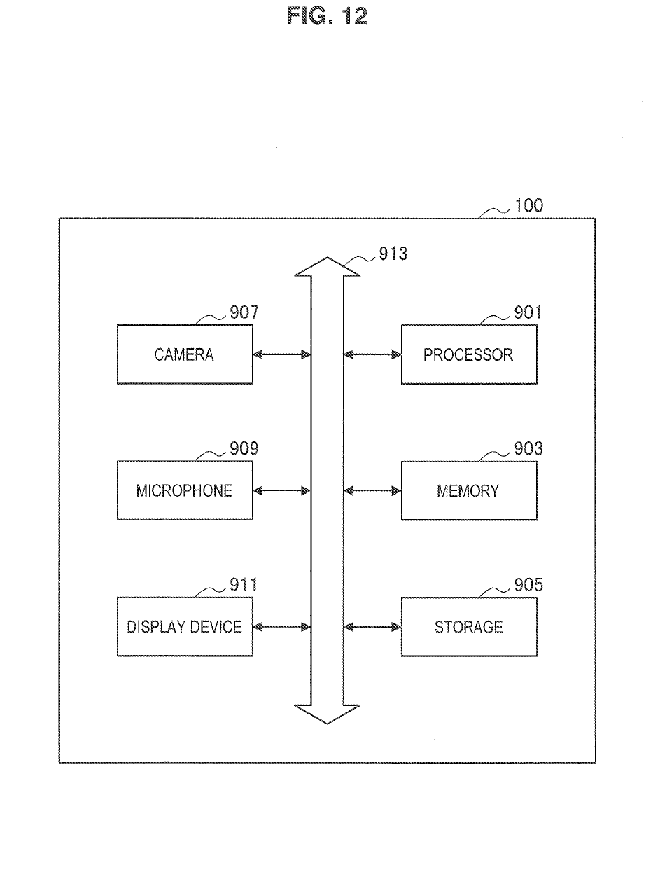

Next, an example of a hardware configuration of the image capture device 100 according to the present embodiment will be described with reference to FIG. 12. FIG. 12 is a block diagram illustrating an example of a hardware configuration of an image capture device 100 according to the present embodiment. Referring to FIG. 12, the image capture device 100 is equipped with a processor 901, memory 903, storage 905, a camera 907, a microphone 909, a display device 911, and a bus 913.

The processor 901 is a component such as a central processing unit (CPU), a digital signal processor (DSP), or a system on a chip (SoC), for example, and executes various processes of the image capture device 100. The memory 903 includes random access memory (RAM) and read-only memory (ROM), and stores programs executed by the processor 901 as well as data. The storage 905 may include a storage medium such as semiconductor memory or a hard disk.

The camera 907 includes an image sensor such as a charge-coupled device (CCD) or a complementary metal-oxide-semiconductor (CMOS) sensor, a processor circuit, and the like, for example. In the present embodiment, the camera 907 has an angle of view of 180 degrees or more.

The microphone 909 converts input audio into an audio signal. In the present embodiment, the microphone 909 is a directional microphone, and includes multiple microphone elements.

The display device 911 is a liquid crystal display or an organic light-emitting diode (OLED) display, for example.

The bus 913 interconnects the processor 901, the memory 903, the storage 905, the camera 907, the microphone 909, and the display device 911. The bus 913 may also include multiple types of busses.

Note that the camera 907, the microphone 909, and the display device 911 respectively correspond to the camera 101, the microphone 103, and the display device 105 described with reference to FIG. 1.

Additionally, the image capture unit 110 described with reference to FIG. 4 may also be implemented by the camera 907. Alternatively, at least part of the image capture unit 110 may be implemented by the camera 907, while at least another part of the image capture unit 110 may be implemented by the processor 901 and the memory 903. The audio pickup unit 120 may also be implemented by the microphone 909. Alternatively, at least part of the audio pickup unit 120 may be implemented by the microphone 909, while at least another part of the audio pickup unit 120 may be implemented by the processor 901 and the memory 903. The display unit 130 may be implemented by the display device 911. The storage unit 140 may be implemented by the storage 905. In addition, the control unit 150 may be implemented by the processor 901 and the memory 903.

### 3. PROCESS FLOW

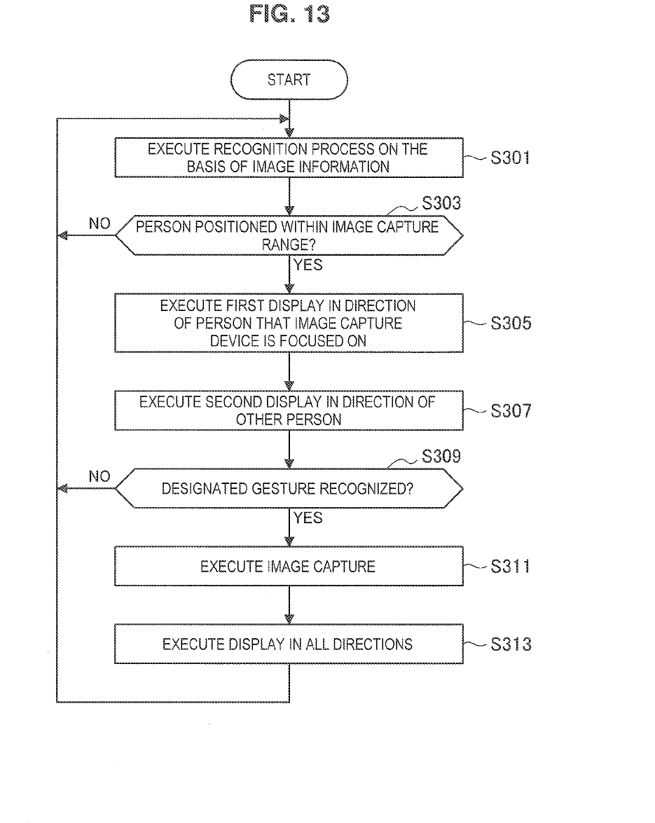

Next, an example of information processing according to the present embodiment will be described with reference to FIG. 13. FIG. 13 is a flowchart illustrating an example of a diagrammatic flow of information processing according to the present embodiment.

First, the recognition unit 151 conducts a recognition process on the basis of image information about the space surrounding the image capture device 100 (S301). For example, the recognition process includes a facial recognition process and a gesture recognition process.

If a person is positioned within the image capture range (that is, if a person's face is recognized) (S303: Yes), under control by the notification unit 153, the display unit 130 presents a first display (for example, the display of a blinking image) in the direction of the person that the image capture device 100 is focused on (S305). Note that if the image capture device 100 is not focused on a person, the first display is not presented. Also, under control by the notification unit 153, the display unit 130 presents a second display (for example, the display of a non-blinking image) in the direction of another person (S307). Note that if another person is not present, the second display is not presented.

Also, if a designated gesture is recognized (S309: Yes), the image capture unit 110 executes image capture under control by the image capture control unit 157 (S311). As a result, captured image information is generated. Also, under control by the notification unit 153, the display unit 130 presents a display in all directions (S313). Subsequently, the process returns to step S301.

Note that if no person is positioned within the image capture range (that is, if a person's face is not recognized) (S303: No), or if a designated gesture is not recognized (S309: No), the process returns to step S301.

### 4. EXEMPLARY MODIFICATIONS

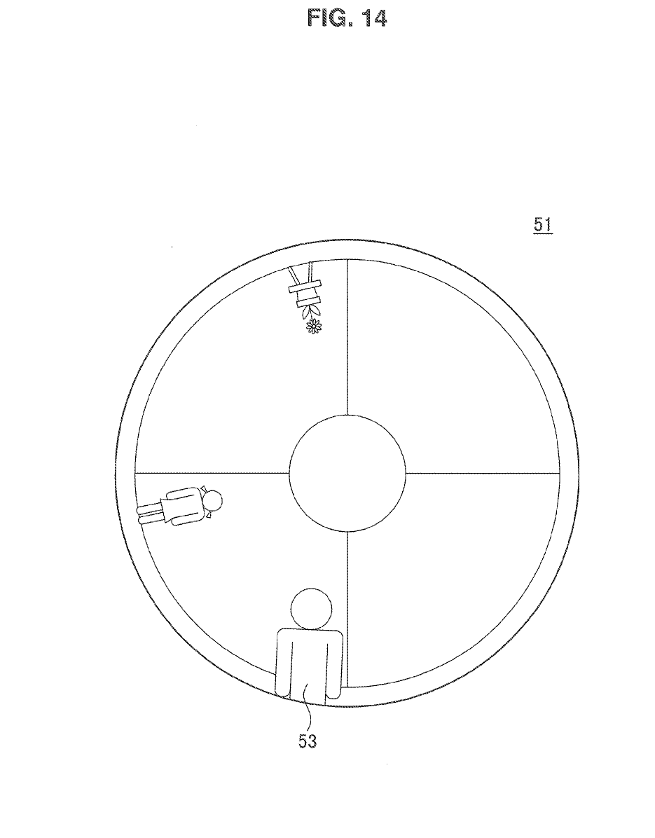

Next, first to fourth exemplary modifications of the present embodiment will be described with reference to FIGS. 14 to 19.

<4.1. First Exemplary Modification>

First, a first exemplary modification of the present embodiment will be described with reference to FIGS. 14 to 16. In the first exemplary modification, captured image information corresponding to the position of a designated subject in the image capture range of the image capture device 100 is generated. Consequently, it becomes possible to view a more desirable captured image, for example.

(Image Processing Unit 159)

As discussed earlier, the image processing unit 159 conducts some kind of image processing. Particularly, in the first exemplary modification, when the image capture is executed, the image processing unit 159 generates captured image information corresponding to the position of a designated subject in the image capture range of the image capture device 100.

For example, as discussed earlier, when the image capture unit 110 conducts image capture, captured image information is generated. Subsequently, the image processing unit 159 acquires the captured image information and information on the position of a designated subject. Subsequently, on the basis the captured image information, the image processing unit 159 generates captured image information corresponding to the position of the designated subject in the image capture range of the image capture device 100 (that is, new captured image information). The designated subject may be a person, for example. As an example, the person may be a person who performed a gesture.

### FIRST EXAMPLE

For example, the captured image information generated by the image processing unit 159 is information of an image depicting the designated subject at a designated position. Hereinafter, a specific example regarding this point will be described with reference to FIG. 14.

FIG. 14 is an explanatory diagram for illustrating an example of a captured image depicting a designated subject at a designated position. Referring to FIG. 14, a captured image 51 is illustrated. In this example, the captured image 51 is a full dome image. For example, when the captured image 41 illustrated in FIG. 10 (a full dome image) is generated, the image processing unit 159, on the basis of the captured image information of the captured image 41 depicting a designated subject (for example, a person who performed a gesture) at a position 43, generates the captured image information of the captured image 51 depicting the designated subject at a designated position 53. In this example, the image processing unit 159 generates the captured image information of the captured image 51 by applying a rotation process to the captured image information of the captured image 41, for example.

Consequently, it becomes possible to generate captured image information of a captured image depicting a designated subject (for example, a person who performed a gesture) at an easier-to-see position, for example. In other words, captured image information of a more desirable captured image is generated. For this reason, it becomes possible to view a more desirable captured image.

### SECOND EXAMPLE

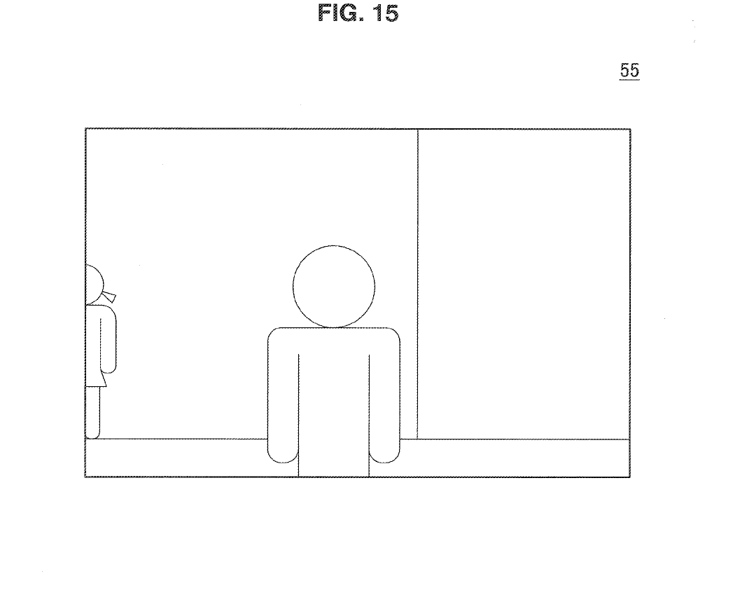

As another example, the captured image information generated by the image processing unit 159 is information of an image depicting a partial range that includes the above position of the designated subject from the image capture range. Hereinafter, a specific example regarding this point will be described with reference to FIG. 15.

FIG. 15 is an explanatory diagram for illustrating an example of a captured image depicting a partial range that includes the position of a designated subject from an image capture range. Referring to FIG. 15, a captured image 55 is illustrated. For example, when the captured image 45 illustrated in FIG. 11 (a panoramic image) is generated, the image processing unit 159, on the basis of the captured image information of the captured image 41 depicting a designated subject (for example, a person who performed a gesture) at a position 47, generates the captured image information of the captured image 55 depicting a partial range that includes the position 47 from the image capture range. In this example, the image processing unit 159 generates the captured image information of the captured image 55 by applying a trimming process to the captured image information of the captured image 45, for example. Note that the captured image 55 may also be generated from the 41 illustrated in FIG. 10 (a full dome image).

Consequently, it becomes possible to generate captured image information of a captured image over a limited range that includes a designated subject (for example, a person who performed a gesture), for example. In other words, captured image information of a more desirable captured image is generated. For this reason, it becomes possible to view a more desirable captured image.

For example, as above, captured image information corresponding to the position of a designated subject in the image capture range of the image capture device 100 is generated. Consequently, it becomes possible to view a more desirable captured image, for example.

Note that if an image capture device having a narrow angle of view is used, a person moves or the orientation of the image capture device is changed in order to conduct image capture. However, if the image capture device 100 having a wide angle of view (for example, an angle of view of 360 degrees) is used, it is not necessary for the person to move, nor is it necessary to change the orientation of the image capture device 100. As a result, there is also a possibility that a person may be depicted at a hard-to-see position in the captured image. For this reason, captured image generation as discussed above is particularly useful for an image capture device having a wide angle of view.

(Process Flow)

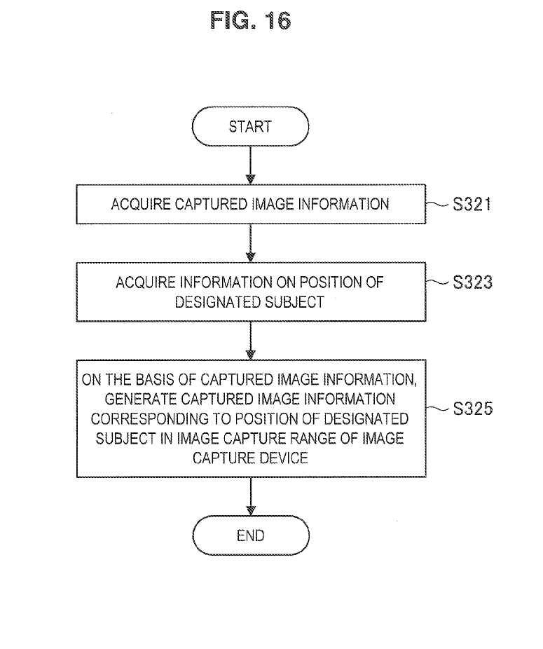

FIG. 16 is a flowchart illustrating an example of a diagrammatic flow of information processing according to the first exemplary modification of the present embodiment. This information processing is executed when captured image information is generated.

First, the image processing unit 159 acquires captured image information (S321). In addition, the image processing unit 159 acquires information on the position of a designated subject (for example, a person who performed gesture) (S323).

Subsequently, on the basis of the captured image information, the image processing unit 159 generates captured image information corresponding to the position of the designated subject in the image capture range of the image capture device 100 (S325). The process then ends.

<4.2. Second Exemplary Modification>

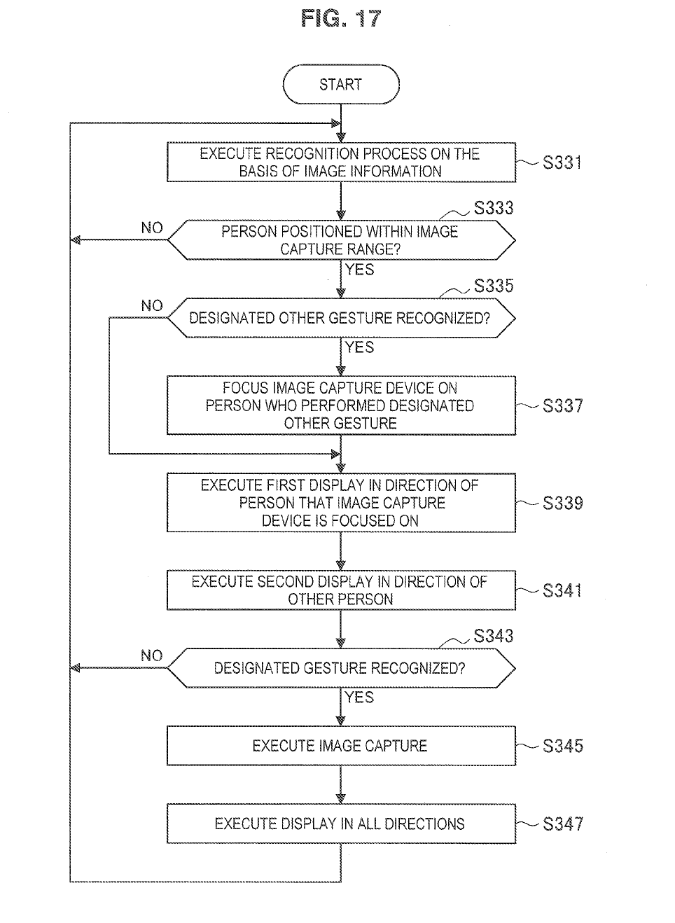

Next, a second exemplary modification of the present embodiment will be described with reference to FIG. 17. In the second exemplary modification, the focus of the image capture device 100 is controlled according to another recognition result based on image information or audio information about the space surrounding the image capture device 100. Consequently, it becomes easy to focus an image capture device 100 having a wide angle of view, for example.

(Recognition Unit 151)

Particularly, in the second exemplary modification, the recognition unit 151 conducts another recognition based on image information or audio information about the space surrounding the image capture device 100.

For example, the recognition unit 151 recognizes a designated other gesture on the basis of the image information. As an example, the designated other gesture may be raising one's hand. Note that this gesture (raising one's hand) is merely a single example, and that a variety of gestures are applicable.

(Recognition Result Acquisition Unit 155)

Particularly, in the second exemplary modification, the recognition result acquisition unit 155 acquires another recognition result based on image information or audio information about the space surrounding the image capture device 100.

For example, the recognition result acquisition unit 155 acquires another recognition result based on the image information. Specifically, the recognition is the recognition of another designated gesture based on the image information, for example. In other words, the recognition result acquisition unit 155 acquires a recognition result for a designated other gesture based on the image information. For example, if the designated other gesture is recognized, the recognition result acquisition unit 155 acquires a recognition result indicating that the designated other gesture was recognized.

(Image Capture Control Unit 157)

Focus Control

Particularly, in the second exemplary modification, the image capture control unit 157 controls the focus of the image capture device 100 according to the result of the other recognition.

For example, if the recognition result acquisition unit 155 acquires another recognition result based on the image information, the image capture control unit 157 controls the focus the image capture device 100 according to the result of the other recognition.

Specifically, the recognition is the recognition of a designated other gesture (for example, raising one's hand) based on the image information, for example. If the result of the other recognition indicates that the designated other gesture was recognized, the image capture control unit 157 controls the focus of the image capture device 100 so that the image capture device 100 is focused on the person who performed the designated other gesture.

Consequently, it becomes easy to focus an image capture device 100 having a wide angle of view, for example.

(Process Flow)

FIG. 17 is a flowchart illustrating an example of a diagrammatic flow of information processing according to the second exemplary modification of the present embodiment.

Herein, steps S331, S333, and S339 to S347 in FIG. 17 are the same as steps S301 to S313 described with reference to FIG. 13. Consequently, only steps S335 and S337 will be described herein.

If a designated other gesture is recognized (S335: Yes), under control by the image capture control unit 157, the image capture control unit 157 is focused on the person who performed the designated other gesture (S337).

The foregoing thus describes the second exemplary modification of the present embodiment. Note that obviously the processes described in the first exemplary modification are also applicable to the second exemplary modification.

<4.3. Third Exemplary Modification>

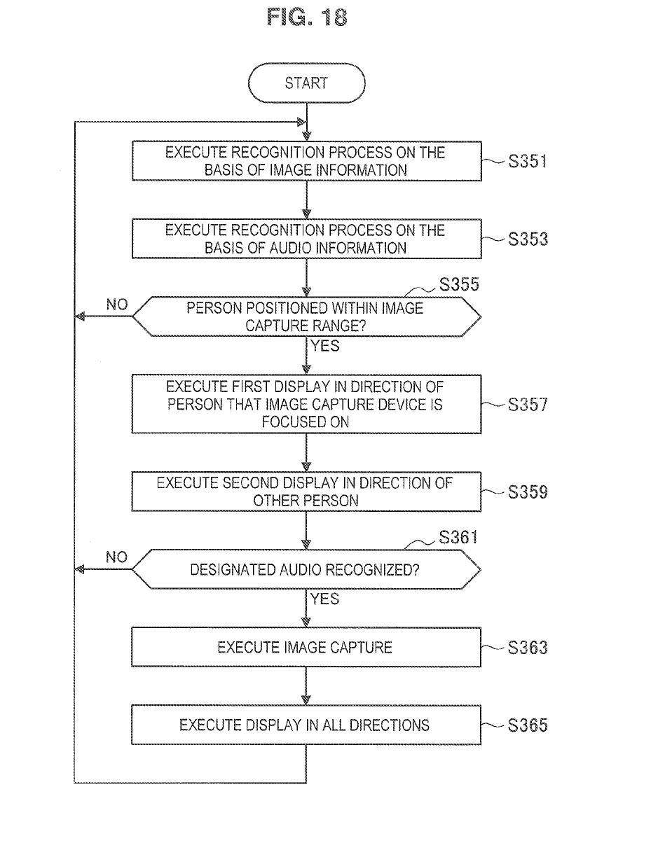

Next, a third exemplary modification of the present embodiment will be described with reference to FIG. 18. As discussed earlier, in the present embodiment, the execution of image capture is controlled according to the recognition of a designated gesture based on image information, for example. On the other hand, in the third exemplary modification, the execution of image capture is controlled according to the recognition of designated audio based on audio information. Consequently, since image capture is conducted during a scene that a person wants to capture, and the result of the image capture is saved, for example, it becomes possible to view only scenes that a person intentionally wanted to capture. Furthermore, it becomes possible for a person who is a subject of an image to intentionally cause the image capture device 100 to capture an image, for example. Also, it becomes possible for a person who is a subject of an image to easily cause the image capture device 100 to capture an image from any position, for example. In other words, advantageous effects similar to the case of gesture recognition may be obtained.

(Recognition Unit 151)

As discussed earlier, in the present embodiment, the recognition unit 151 conducts recognition on the basis of image information or audio information about the space surrounding the image capture device 100.

Recognition of Designated Audio

Particularly, in the third exemplary modification, the recognition unit 151 recognizes designated audio on the basis of the audio information.

As an example, the designated audio is audio for a designated word. The designated word may be a word such as “photo”, “video”, or “shoot”. As another example, the designated audio may also be audio for a designated phrase. The designated phrase may be a phrase such as “take a photo”, “record a video”, or “over here”.

(Recognition Result Acquisition Unit 155)

As discussed earlier, in the present embodiment, the recognition result acquisition unit 155 acquires a recognition result based on image information or audio information about the space surrounding the image capture device 100.

Particularly, in the third exemplary modification, the recognition result acquisition unit 155 acquires a recognition result based on the audio information. Furthermore, the recognition is the recognition of designated audio based on the audio information. In other words, the recognition result acquisition unit 155 acquires a recognition result for designated audio based on the audio information. For example, if the designated audio is recognized, the recognition result acquisition unit 155 acquires a recognition result indicating that the designated audio was recognized.

(Image capture control unit 157)

Control of Image Capture Execution

As discussed earlier, in the present embodiment, the image capture control unit 157 controls the execution of image capture by the image capture device 100 according to the result of the recognition.

Particularly, in the third exemplary modification, the recognition is the recognition of designated audio based on the audio information. If the result of the recognition indicates that the designated audio was recognized, the image capture control unit 157 causes the image capture unit 110 to conduct image capture. As a result, captured image information is generated.

(Process Flow)

FIG. 18 is a flowchart illustrating an example of a diagrammatic flow of information processing according to the third exemplary modification of the present embodiment.

First, the recognition unit 151 conducts a recognition process on the basis of image information about the space surrounding the image capture device 100 (S351). The recognition process is a facial recognition process, for example.

Also, the recognition unit 151 conducts a recognition process on the basis of audio information about the space surrounding the image capture device 100 (S353). The recognition process is a speech recognition process, for example.

If a person is positioned within the image capture range (that is, if a person's face is recognized) (S355: Yes), under control by the notification unit 153, the display unit 130 presents a first display (for example, the display of a blinking image) in the direction of the person that the image capture device 100 is focused on (S357). Note that if the image capture device 100 is not focused on a person, the first display is not presented. Also, under control by the notification unit 153, the display unit 130 presents a second display (for example, the display of a non-blinking image) in the direction of another person (S359). Note that if another person is not present, the second display is not presented.

Also, if a designated audio is recognized (S361: Yes), the image capture unit 110 executes image capture under control by the image capture control unit 157 (S363). As a result, captured image information is generated. Also, under control by the notification unit 153, the display unit 130 presents a display in all directions (S365). Subsequently, the process returns to step S351.

Note that if no person is positioned within the image capture range (that is, if a person's face is not recognized) (S355: No), or if a designated audio is not recognized (S361: No), the process returns to step S351.

The foregoing thus describes the third exemplary modification of the present embodiment. Note that obviously the processes described in the first exemplary modification and the second exemplary modification are also applicable to the third exemplary modification.

Also, in the third exemplary modification, the execution of image capture by the image capture device 100 is controlled according to the recognition of designated audio based on audio information, but in the second exemplary modification, the focus of the image capture device 100 may also be controlled according to the recognition of designated audio based on audio information.

<4.4. Fourth Exemplary Modification>

Next, a third exemplary modification of the present embodiment will be described with reference to FIG. 18. As discussed earlier, in the present embodiment, the execution of image capture is controlled according to the recognition of a designated gesture based on image information, for example. On the other hand, in the fourth exemplary modification, the execution of image capture is controlled according to the recognition of a designated subject based on image information. Consequently, since image capture is conducted during a scene in which a designated subject (for example, a person) is present in the image capture range, and the result of the image capture is saved, for example, it becomes possible to view only scenes depicting a person.

(Recognition Unit 151)

As discussed earlier, the recognition unit 151 conducts recognition on the basis of image information or audio information about the space surrounding the image capture device 100.

Recognition of a Designated Subject

As discussed earlier, for example, the recognition unit 151 recognizes a designated subject on the basis of the image information or the audio information. For example, the designated subject may be a person.

(Recognition Result Acquisition Unit 155)

As discussed earlier, in the present embodiment, the recognition result acquisition unit 155 acquires a recognition result based on image information or audio information about the space surrounding the image capture device 100.

Particularly, in the fourth exemplary modification, the recognition is the recognition of a designated subject based on the image information or the audio information. In other words, the recognition result acquisition unit 155 acquires a recognition result for a designated subject based on the image information or the audio information. For example, if the designated subject is recognized, the recognition result acquisition unit 155 acquires a recognition result indicating that the designated subject was recognized. As discussed earlier, the designated subject may be a person, for example.

(Image Capture Control Unit 157)

Control of Image Capture Execution

As discussed earlier, in the present embodiment, the image capture control unit 157 controls the execution of image capture by the image capture device 100 according to the result of the recognition.

Particularly, in the fourth exemplary modification, the recognition is the recognition of a designated subject based on the image information or the audio information. If the result of the recognition indicates that the designated subject was recognized, the image capture control unit 157 causes the image capture unit 110 to conduct image capture. As a result, captured image information is generated. As discussed earlier, the designated subject may be a person, for example.

(Process Flow)

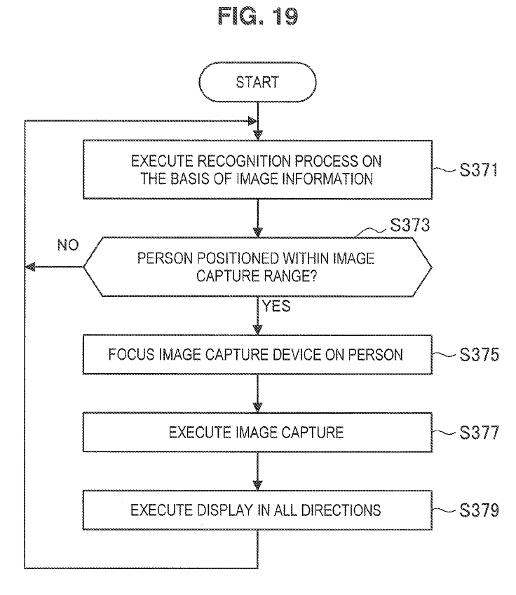

FIG. 19 is a flowchart illustrating an example of a diagrammatic flow of information processing according to the fourth exemplary modification of the present embodiment.

First, the recognition unit 151 conducts a recognition process on the basis of image information about the space surrounding the image capture device 100 (S371). The recognition process is a facial recognition process, for example.

If a person is positioned within the image capture range (that is, if a person's face is recognized (S373: Yes), under control by the image capture control unit 157, the image capture control unit 157 is focused on the person (S375). Subsequently, the image capture unit 110 executes image capture under control by the image capture control unit 157 (S377). As a result, captured image information is generated. Also, under control by the notification unit 153, the display unit 130 presents a display in all directions (S379). Subsequently, the process returns to step S371.

Note that if no person is positioned within the image capture range (that is, if a person's face is not recognized) (S373: No), the process returns to step S371.

The foregoing thus describes the fourth exemplary modification of the present embodiment. Note that obviously the processes described in the first exemplary modification are also applicable to the fourth exemplary modification.

### 5. CONCLUSION

The foregoing thus describes an image capture device and respective processes according to an embodiment of the present disclosure with reference to FIGS. 1 to 19. According to an embodiment of the present disclosure, the recognition result acquisition unit 155 acquires a recognition result based on image information or audio information about the space surrounding an image capture device 100 having an angle of view of 180 degrees or more. The image capture control unit 157 then controls the execution of image capture by the image capture device 100 according to the result of the recognition. Consequently, it becomes possible to efficiently view the result of image capture by an image capture device having a wide angle of view. More specifically, since image capture is conducted in the case of any recognition (for example, recognition of a gesture), for example, image capture is conducted in a scene that is at least meaningful enough to be captured (for example, a scene that a person wants to capture), and the result of the image capture is saved. For this reason, by viewing the results of such image capture, it becomes possible to view only scenes having some kind of meaning. In this way, it becomes possible to efficiently view the result of image capture.

Notification a Person

Further, the notification unit 153, for example, notifies a person positioned within the image capture range of the image capture device 100.

For example, the notification unit 153 conducts the notification when the person is positioned within the image capture range. Consequently, it becomes possible for a person to know that he or she is positioned within the image capture range of the image capture device 100, for example. Particularly, if an image capture device having a wide angle of view (for example, an angle of view of 360 degrees) is installed, a person may have difficulty judging whether or not he or she is positioned within the image capture range of the image capture device. Alternatively, a person may have difficulty noticing that he or she is positioned within the image capture range of the image capture device. For this reason, when an image capture device having a wide angle of view is used in particular, notification as discussed above is useful.

Also, the notification unit 153 conducts the notification when the image capture device 100 is focused on the person, for example. Consequently, it becomes possible for a person to know that the image capture device 100 is focused on him or her, for example. Particularly, if an image capture device having a wide angle of view (for example, an angle of view of 360 degrees) is installed, a person may have difficulty judging where the image capture device 100 is focused on. For this reason, when an image capture device having a wide angle of view is used in particular, notification as discussed above is useful.

Also, the notification unit 153 conducts the notification when the image capture device 100 conducts the image capture, for example. Consequently, it becomes possible for a person to know whether or not image capture is being executed. Particularly, if an image capture device having a wide angle of view (for example, an angle of view of 360 degrees) is installed, a person may have difficulty judging whether or not he or she is being captured. For this reason, when an image capture device having a wide angle of view is used in particular, notification as discussed above is useful.

Also, the notification unit 153 conducts the above notification by controlling the display presented by the display device, for example. Consequently, it becomes possible to notify a person without being affected by ambient noise, for example.

Additionally, the display device is provided in the image capture device 100, for example. Consequently, it becomes possible to reliably notify a person looking at the image capture device 100, for example.

Also, for example, the notification unit 153 conducts the notification by controlling the display so that the display device presents a display in the direction of the person. According to notification using such a display, for example, it becomes possible to more reliably notify a specific person.

Recognition

In addition, the recognition is the recognition of a designated gesture based on the image information, for example. Consequently, since image capture is conducted during a scene that a person wants to capture, and the result of the image capture is saved, for example, it becomes possible to view only scenes that a person intentionally wanted to capture. Furthermore, it becomes possible for a person who is a subject of an image to intentionally cause the image capture device 100 to capture an image, for example. Also, it becomes possible for a person who is a subject of an image to easily cause the image capture device 100 to capture an image from any position, for example.

Also, according to the third exemplary modification, the recognition is the recognition of designated audio based on the audio information. Consequently, since image capture is conducted during a scene that a person wants to capture, and the result of the image capture is saved, for example, it becomes possible to view only scenes that a person intentionally wanted to capture. Furthermore, it becomes possible for a person who is a subject of an image to intentionally cause the image capture device 100 to capture an image, for example. Also, it becomes possible for a person who is a subject of an image to easily cause the image capture device 100 to capture an image from any position, for example.

Also, according to the fourth exemplary modification, the recognition is the recognition of a designated subject based on the image information or the audio information. Consequently, since image capture is conducted during a scene in which a designated subject (for example, a person) is present in the image capture range, and the result of the image capture is saved, for example, it becomes possible to view only scenes depicting a person.

Captured Image Corresponding to Position of Designated Subject

Also, according to the first exemplary modification, when the image capture is executed, the image processing unit 159 generates captured image information corresponding to the position of a designated subject in the image capture range of the image capture device 100. Consequently, it becomes possible to view a more desirable captured image, for example.

Note that if an image capture device having a narrow angle of view is used, a person moves or the orientation of the image capture device is changed in order to conduct image capture. However, if the image capture device 100 having a wide angle of view (for example, an angle of view of 360 degrees) is used, it is not necessary for the person to move, nor is it necessary to change the orientation of the image capture device 100. As a result, there is also a possibility that a person may be depicted at a hard-to-see position in the captured image. For this reason, captured image generation as discussed above is particularly useful for an image capture device having a wide angle of view.

As a first example, the captured image information is information of an image depicting the designated subject at a designated position. Consequently, it becomes possible to generate captured image information of a captured image depicting a designated subject (for example, a person who performed a gesture) at an easier-to-see position, for example. In other words, captured image information of a more desirable captured image is generated. For this reason, it becomes possible to view a more desirable captured image.

As a second example, the captured image information is information of an image depicting a partial range of the image capture range that includes the position of the designated subject.

Consequently, it becomes possible to generate captured image information of a captured image over a limited range that includes a designated subject (for example, a person who performed a gesture), for example. In other words, captured image information of a more desirable captured image is generated. For this reason, it becomes possible to view a more desirable captured image.

Focus Control

Also, according to the second exemplary modification, the recognition result acquisition unit 155 acquires another recognition result based on image information or audio information about the space surrounding the image capture device 100. The image capture control unit 157 then controls the focus of the image capture device 100 according to the result of the other recognition. Consequently, it becomes easy to focus an image capture device 100 having a wide angle of view, for example.

Other

In addition, the image information is image information generated via the image capture device, for example. Consequently, image information that enables the ascertaining of the correct direction from the image capture device 100 to a subject is obtained.

The foregoing thus describes preferred embodiments of the present disclosure with reference to the attached drawings. However, the present disclosure obviously is not limited to such examples. It is clear to persons skilled in the art that various modifications or alterations may occur insofar as they are within the scope stated in the claims, and it is to be understood that such modifications or alterations obviously belong to the technical scope of the present disclosure.

For example, an example is described in which a facial recognition process is conducted in order to recognize a person, but the present disclosure is not limited to such an example. For example, another recognition process for recognizing a person (such as a process for recognizing a person's body, or a process for recognizing a person's motion, for example) may also be conducted.

Additionally, an example is described in which the recognition of a designated gesture based on image information, the recognition of designated audio based on audio information, and/or the recognition of a designated subject based on image information or audio information are conducted as the recognition based on image information and audio information, but the recognition according to the present disclosure is not limited to such an example. For example, the recognition of audio of a magnitude exceeding a designated magnitude may also be conducted on the basis of audio information. Subsequently, the execution of image capture by the image capture device may be controlled according to the recognition of audio of a magnitude exceeding the designated magnitude, for example. In addition, the focus of the image capture device may be controlled according to the recognition of audio of a magnitude exceeding the designated magnitude, for example. In this way, various recognitions are applicable in the present disclosure.

Also, an example is described in which the information processing device according to the present disclosure is the image capture device itself, but the present disclosure is not limited to such an example. For example, an information processing device according to the present disclosure (that is, a device that at least includes a recognition result acquisition unit and an image capture control unit) may also be a device included in an image capture device as discussed earlier. As one example, the information processing device according to the present disclosure may be any chip mounted onboard the image capture device. Alternatively, the information processing device according to the present disclosure may be a separate device that controls an image capture device from outside that image capture device. In this case, the information processing device according to the present disclosure may directly or indirectly communicate with the image capture device.

Also, the processing steps in the information processing in this specification are not strictly limited to being executed in a time series following the sequence described in a flowchart. For example, the processing steps in the information processing may be executed in a sequence that differs from a sequence described herein as a flowchart, and furthermore may be executed in parallel.

Additionally, it is possible to create a computer program for causing hardware such as a CPU, ROM, and RAM built into an information processing device (for example, an image capture device) to exhibit functions similar to each structural element of the above information processing device. Also, a storage medium having such a computer program stored therein may also be provided. Also, an information processing device (for example, a processing circuit or chip) equipped with memory storing such a computer program (for example, ROM and RAM) and one or more processors capable of executing such a computer program (such as a CPU or DSP, for example) may also be provided.

In addition, the advantageous effects described in this specification are merely for the sake of explanation or illustration, and are not limiting. In other words, instead of or in addition to the above advantageous effects, technology according to the present disclosure may exhibit other advantageous effects that are clear to persons skilled in the art from the description of this specification.

(1) An information processing device including:

an acquisition unit that acquires a result of a recognition based on image information or audio information about space surrounding an image capture device having an angle of view of 180 degrees or more; and

an image capture control unit that controls execution of image capture by the image capture device according to the result of the recognition.

(2) The information processing device according to (1), further including:

a notification unit that notifies a person positioned within an image capture range of the image capture device.

(3) The information processing device according to (2), wherein

the notification unit conducts the notification when the person is positioned within the image capture range.

(4) The information processing device according to (2) or (3), wherein

the notification unit conducts the notification when the image capture device is focused on the person.

(5) The information processing device according to any one of (2) to (4), wherein

the notification unit conducts the notification when the image capture is conducted by the image capture device.

(6) The information processing device according to any one of (2) to (5), wherein

the notification unit conducts the notification by controlling a display by a display device.

(7) The information processing device according to (6), wherein

the display device is provided by the image capture device.

(8) The information processing device according to (7), wherein

the notification unit conducts the notification by controlling the display so that the display device presents a display in a direction of the person.

(9) The information processing device according to any one of (1) to (8), wherein

the recognition is recognition of a designated gesture based on the image information.

(10) The information processing device according to any one of (1) to (8), wherein

the recognition is recognition of designated audio based on the audio information.

(11) The information processing device according to any one of (1) to (8), wherein

the recognition is recognition of a designated subject based on the image information or the audio information.

(12) The information processing device according to any one of (1) to (11), further including:

an image processing unit that, when the image capture is executed, generates captured image information corresponding to a position of a designated subject in an image capture range of the image capture device.

(13) The information processing device according to (12), wherein

the captured image information is information of an image depicting the designated subject at a designated position.

(14) The information processing device according to (12) or (13), wherein

the captured image information is information of an image depicting a partial range of the image capture range that includes the position of the designated subject.

(15) The information processing device according to any one of (1) to (14), wherein

the acquisition unit acquires a result of another recognition based on image information or audio information about space surrounding the image capture device, and

the image capture control unit controls focus of the image capture device according to the result of the other recognition.

(16) The information processing device according to any one of (1) to (15), wherein

the image information is image information generated via the image capture device.

(17) The information processing device according to any one of (1) to (16), wherein

the information processing device is the image capture device, a device included in the image capture device, or a device that controls the image capture device from outside the image capture device.

(18) An information processing method including:

acquiring a result of a recognition based on image information or audio information about space surrounding an image capture device having an angle of view of 180 degrees or more; and

controlling, with a processor, image capture by the image capture device according to the result of the recognition.

(19) A program causing a computer to execute:

acquiring a result of a recognition based on image information or audio information about space surrounding an image capture device having an angle of view of 180 degrees or more; and

controlling image capture by the image capture device according to the result of the recognition.

What is claimed is:

1. An information processing device comprising:
an acquisition unit that acquires a result of a recognition based on image information or audio information about space surrounding an image capture device having an angle of view of 180 degrees or more; and
an image capture control unit that controls execution of image capture by the image capture device according to the result of the recognition.

2. The information processing device according to claim 1, further comprising:
a notification unit that notifies a person positioned within an image capture range of the image capture device.

3. The information processing device according to claim 2, wherein
the notification unit conducts the notification when the person is positioned within the image capture range.

4. The information processing device according to claim 2, wherein
the notification unit conducts the notification when the image capture device is focused on the person.

5. The information processing device according to claim 2, wherein
the notification unit conducts the notification when the image capture is conducted by the image capture device.

6. The information processing device according to claim 2, wherein
the notification unit conducts the notification by controlling a display by a display device.

7. The information processing device according to claim 6, wherein
the display device is provided by the image capture device.

8. The information processing device according to claim 7, wherein
the notification unit conducts the notification by controlling the display so that the display device presents a display in a direction of the person.

9. The information processing device according to claim 1, wherein
the recognition is recognition of a designated gesture based on the image information.

10. The information processing device according to claim 1, wherein
the recognition is recognition of designated audio based on the audio information.

11. The information processing device according to claim 1, wherein
the recognition is recognition of a designated subject based on the image information or the audio information.

12. The information processing device according to claim 1, further comprising:
an image processing unit that, when the image capture is executed, generates captured image information corresponding to a position of a designated subject in an image capture range of the image capture device.

13. The information processing device according to claim 12, wherein
the captured image information is information of an image depicting the designated subject at a designated position.

14. The information processing device according to claim 12, wherein
the captured image information is information of an image depicting a partial range of the image capture range that includes the position of the designated subject.

15. The information processing device according to claim 1, wherein
the acquisition unit acquires a result of another recognition based on image information or audio information about space surrounding the image capture device, and
the image capture control unit controls focus of the image capture device according to the result of the other recognition.

16. The information processing device according to claim 1, wherein
the image information is image information generated via the image capture device.

17. The information processing device according to claim 1, wherein
the information processing device is the image capture device, a device included in the image capture device, or a device that controls the image capture device from outside the image capture device.

18. An information processing method comprising:
acquiring a result of a recognition based on image information or audio information about space surrounding an image capture device having an angle of view of 180 degrees or more; and
controlling, with a processor, image capture by the image capture device according to the result of the recognition.

19. A program causing a computer to execute:
acquiring a result of a recognition based on image information or audio information about space surrounding an image capture device having an angle of view of 180 degrees or more; and
controlling image capture by the image capture device according to the result of the recognition.
